(19) United States
(12) Patent Application Publication
(10) Pub. No.: US 2026/0088582 A1
(43) Pub. Date: Mar. 26, 2026

(54) OPTICAL DEVICES INCLUDING MODE FIELD ADAPTERS HAVING CORELESS AND GRADED INDEX OPTICAL FIBERS

(71) Applicant: The Government of the United States of America, as represented by the Secretary of the Navy, Arlington, VA (US)

(72) Inventors: Rafael R. Gattass, Washington, DC (US); Augustus X. Carlson, Churchville, MD (US); Patrick M. Hemmer, Bowie, MD (US); Leslie Brandon Shaw, Woodbridge, VA (US); Jasbinder S. Sanghera, Ashburn, VA (US)

(73) Assignee: The Government of the United States of America, as represented by the Secretary of the Navy, Arlington, VA (US)

(21) Appl. No.: 19/303,545

(22) Filed: Aug. 19, 2025

Related U.S. Application Data
(60) Provisional application No. 63/698,080, filed on Sep. 24, 2024.

(51) Int. Cl. H01S 3/067; G02B 6/255; G02F 1/355

(52) U.S. Cl. CPC H01S 3/06741; G02B 6/255; G02F 1/3551; H01S 3/06754

(57) ABSTRACT

According to some embodiments disclosed herein, an optical device includes an optical source, a mode field adapter, and an optical output fiber. The optical source is configured to provide source light having a first mode field diameter at a wavelength of the source light. The mode field adapter includes a coreless optical fiber and a graded index optical fiber optically coupled in series with the optical source. The mode field adapter is configured to receive the source light and to provide output light having a second mode field diameter at the wavelength of the source light, and the first and second mode field diameters are different. The optical output fiber has the second mode field diameter at the wavelength. The mode field adapter is optically coupled between the optical source and the optical output fiber. The optical output fiber and the mode field adapter are joined by a splice.

### CROSS-REFERENCE TO RELATED APPLICATIONS

This application is a Nonprovisional Utility Patent application and claims the benefit of priority under 35 U.S.C. Sec. 119 based on U.S. Provisional Patent Application No. 63/698,080 filed on Sep. 24, 2024. The disclosures of Provisional Application No. 63/698,080 and all references cited herein are hereby incorporated in their entirety by reference into the present disclosure.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, D.C. 20375, USA; +1.202.767.7230; nrltechtran@us.navy.mil, referencing Navy Case #212017.

### TECHNICAL FIELD

The present disclosure relates to optical systems, and more particularly to optical systems including mode field adapters.

### BACKGROUND

Fiber optical systems can include multiple fiber types with each fiber having distinct material, optical, and/or geometrical properties. Efficient and reliable junctions between fibers may require that the light propagating in one fiber be efficiently coupled to a next fiber and that junctions between fibers be stable. One approach to provide mechanically stable connections is to perform a fusion splice between the two optical fibers. An efficiency of coupling can be calculated for light propagating in the fundamental mode of an optical fiber with a near Gaussian spatial distribution. The coupling efficiency η (and hence the loss) at a joint between two optical fibers with respective mode field diameters w₁ and w₂ can be approximated by:

$$η = \frac{4 {w}_{1}^{2} {w}_{2}^{2}}{{( {w}_{1}^{2} + {w}_{2}^{2} )}^{2}} \qquad Equation [ 1 ]$$

Equation [1] shows the impact of matching the mode field between both fibers to increase efficiency (and therefore reduce loss). There are a few methods to match the mode field diameter depending on the fiber type and material. One example is to perform tapering of the fiber diameter to reduce the mode field diameter. For some range of mode field reduction, this is possible but may lead to outer diameter mismatch of fibers. This outer diameter mismatch may reduce the strength of the junction between fibers and/or may reduce/limit bidirectional power handling.

Efficient mode matching between the fibers is understood to occur for fiber mode field mismatches following Equation 1 with transmission above 80%, and more typically above 90%.

The mode field diameter (MFD) of an optical fiber is typically defined to be MFDₓ and MFD_{y} [ISO Standard 11146] according to the equations below:

$${MFD}_{x} = 4 \sqrt{\frac{\int {x}^{2} I ( x , y ) dxdy}{\int I ( x , y ) dxdy}} , \qquad Equation [ 2 a ]$$

$$and$$

$${MFD}_{y} = 4 \sqrt{\frac{\int {y}^{2} I ( x , y ) dxdy}{\int I ( x , y ) dxdy}} . \qquad Equation [ 2 b ]$$

For the case of a symmetric beam profile (e.g., in a cylindrical fiber with a uniform radius in the x and y directions), MFDₓ and MFD_{y} display the same value MFD. For near-gaussian optical modes, the mode field diameter is typically defined as the distance at which the intensity of the mode decreases by 1/e² of its peak value.

Solid core step-index optical fibers are fibers with two different glass compositions, one glass composition for the inner core of the fiber and another glass composition for the outer cladding of the fiber (surrounding the inner core). For these fibers, the mode field diameter will be defined by the wavelength of light, the difference between the core refractive index and the clad refractive index, and the dimensions of the core and the cladding. The numerical aperture (NA) of a fiber is defined as

$$NA = \sqrt{{n}_{core}^{2} - {n}_{cladding}^{2}} . \qquad Equation [ 3 ]$$

A photonic crystal fiber (PCF) is a fiber where optical guidance is defined by the geometrical arrangement of a series of index contrasting structures arranged in the fiber. These structures can be provided by air holes and/or by a material having a different refractive index. A typical cross section of a photonic crystal fiber will show a series of holes geometrically arranged around a center core (typically a solid core). Optical guidance is determined by the dimension(s) of the holes (diameter) and the spacing(s) between holes. In photonic crystal fibers, the optical mode field diameter can be controlled by the geometrical arrangement of the index contrasting structures.

Tapering down the outer diameter of a step-index solid core optical fiber can reduce the mode field diameter but only down to a certain point. As the diameter of the core of the fiber reaches a size close to the wavelength divided by the refractive index of the core, the mode field diameter starts to grow. One such example of this mode field diameter increase for silica fibers is shown in the graph of FIG. 1. FIG. 1 shows the mode field radius (half of the mode field diameter) as a function of the fiber core radius for different values of the numerical aperture (NA).

Another method to alter the mode field diameter of an optical fiber involves thermal treatment of the optical fiber. This method is usually referred to as thermal expansion or thermal diffusion of the core, and may only be applicable to solid core fibers with two distinct solid materials for the core and cladding. In this approach, heat is used to diffuse the interface between the core material and the cladding material, altering the local refractive indexes and changing the numerical aperture. For fibers with NA below 0.1, thermal diffusion may be unable to generate significant mode field diameter changes (e.g., a 5 μm core diameter fiber with 0.12 NA can increase the mode field diameter by a factor of two but it may be extremely hard to reach a factor of 3). This method may be difficult to use with silica photonic crystal fibers with typical air hole arrangements as the fiber is made of silica and cannot diffuse into the air holes.

Optical fibers can be single mode or multi-mode. The case of an optical fiber supporting 10 or fewer modes is typically called a few mode fiber. These fibers are typically used in high power lasers as they can support large mode areas for the fundamental mode. Examples of step index core-clad fibers with few-order modes and large mode areas include: an optical fiber with 25 μm core, 0.065 numerical aperture, and 250 μm cladding; an optical fiber with 25 μm core, 0.065 numerical aperture, and 400 μm cladding; and an optical fiber with 20 μm core, 0.065 numerical aperture, and 400 μm cladding. Typical dimensions for large mode area fibers include: core diameters from 15 μm to 55 μm, numerical apertures from 0.06 to 0.85, and cladding diameters from 250 μm to 500 μm.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

According to some embodiments of inventive concepts, an optical device includes an optical source, a mode field adapter optically coupled with the optical source, and an output optical fiber. The optical source is configured to provide source light having a first mode field diameter at a wavelength of the source light. The mode field adapter includes a coreless optical fiber and a graded index optical fiber optically coupled in series with the optical source, and the mode field adapter is configured to receive the source light having the first mode field diameter from the optical source and to provide output light having a second mode field diameter at the wavelength of the source light. Moreover, the first and second mode field diameters are different. The optical output fiber has the second mode field diameter at the wavelength of the light. The mode field adapter is optically coupled between the optical source and the optical output fiber, and the optical output fiber and the mode field adapter are joined by a splice.

According to some other embodiments of inventive concepts, an optical device includes an optical source, a first mode field adapter optically coupled with the optical source, a nonlinear crystal, a second mode field adapter, and an optical output fiber. The optical source is configured to provide source light having a first mode field diameter at a first wavelength. The first mode field adapter is optically coupled with the optical source, and the first mode field adapter includes a first graded index optical fiber and a first coreless optical fiber optically coupled in series with the optical source. The first mode field adapter is configured to receive the source light having the first mode field diameter from the optical source and to provide first output light having a second mode field diameter at the first wavelength, and the first and second mode field diameters are different. The first graded index optical fiber and the first coreless optical fiber are optically coupled in series between the optical source and the nonlinear crystal, and the nonlinear crystal is configured to receive the first output light from the first mode field adapter. The nonlinear crystal is configured to provide second output light having the second mode field diameter and having a second wavelength different than the first wavelength in response to the first output light. The nonlinear crystal is optically coupled between the first and second mode field adapters, and the second mode field adapter includes a second coreless optical fiber and a second graded index optical fiber optically coupled in series with the nonlinear crystal. The second mode field adapter is configured to receive the second output light, and the second mode field adapter is configured to provide third output light having a third mode field diameter different than the second mode field diameter and having the second wavelength. The optical output fiber has the third mode field diameter at the second wavelength, and the second coreless optical fiber and the second graded index optical fiber are optically coupled in series between the nonlinear crystal and the optical output fiber so that the output optical fiber receives the third output light.

According to still other embodiments of inventive concepts, an optical device includes an optical source, a first mode field adapter, a gain element, a second mode field adapter, and an optical output fiber. The optical source is configured to provide source light having a first mode field diameter at a first wavelength. The first mode field adapter is optically coupled with the optical source, and the first mode field adapter includes a first graded index optical fiber and a first coreless optical fiber optically coupled in series with the optical source. The first mode field adapter is configured to receive the source light having the first mode field diameter from the optical source and to provide first output light having a second mode field diameter at the first wavelength. Moreover, the first and second mode field diameters are different. The first coreless optical fiber and the first graded index optical fiber are optically coupled in series between the optical source and the gain element, and the gain element is configured to amplify the first output light from the first mode field adapter to provide second output light having the second mode field diameter. The gain element is optically coupled between the first and second mode field adapters, and the second mode field adapter includes a second coreless optical fiber and a second graded index optical fiber optically coupled in series. The second mode field adapter is configured to receive the second output light, and the second mode field adapter is configured to provide third output light having a third mode field diameter different than the second mode field diameter. The optical output fiber has the third mode field diameter at the wavelength, and the second coreless optical fiber and the second graded index optical fiber are optically coupled in series between the gain element and the optical output fiber so that the optical output fiber receives the third output light.

### BRIEF DESCRIPTION OF THE DRAWINGS

Examples of embodiments of inventive concepts may be more clearly understood from the following detailed description taken in conjunction with the accompanying drawings in which:

FIG. 1 is a graph illustrating mode field radius (half of the mode field diameter) as a function of fiber core radius for different values of numerical aperture (NA);

FIGS. 2A, 2B, and 2C are schematic illustrations of a mode field adapter according to some embodiments of inventive concepts;

FIG. 3 is a cross-sectional image of a central portion of the mode field adapter of FIGS. 2A, 2B, and 2C according to some embodiments of inventive concepts;

FIG. 4A is a cross-sectional view of a notched region of fiber 201 used to provide a cladding light stripper according to some embodiments of inventive concepts;

FIG. 4B is an image of a 100 mm long notched region on a fiber having a 400 μm outer diameter according to some embodiments of inventive concepts;

FIG. 5 illustrates beam propagation modeling of a mode field adapter structure according to some embodiments of inventive concepts, where the x-axis distances are relative to the distance zero at the junction of the coreless and GRIN fibers of the mode field adapter;

FIG. 6 is a graph illustrating modelled transmission for the scenario of FIG. 5 as a function of different values for the length of the graded index fiber (GIF);

FIGS. 7A and 7B are graphs illustrating absolute transmission for two different designs of mode field adapters according to some embodiments of inventive concepts, where FIGS. 7A and 7B illustrate a broadband wavelength nature of the design, with absolute transmission varying by 10% across the whole transmission range for the design of FIG. 7A and with absolute transmission varying by less than 5% for the design of FIG. 7B;

FIG. 8 illustrates beam propagation modeling of a mode field adapter structure according to some embodiments of inventive concepts where an anti-resonant optical output fiber having a mode field diameter more than three times greater that a mode field diameter of a solid core input fiber;

FIG. 9 is a schematic diagram illustrating a pair of mode field adapters used with a nonlinear crystal according to some embodiments of inventive concepts; and

FIG. 10 is a schematic diagram illustrating a pair of mode field adapters used with a gain element according to some embodiments of inventive concepts.

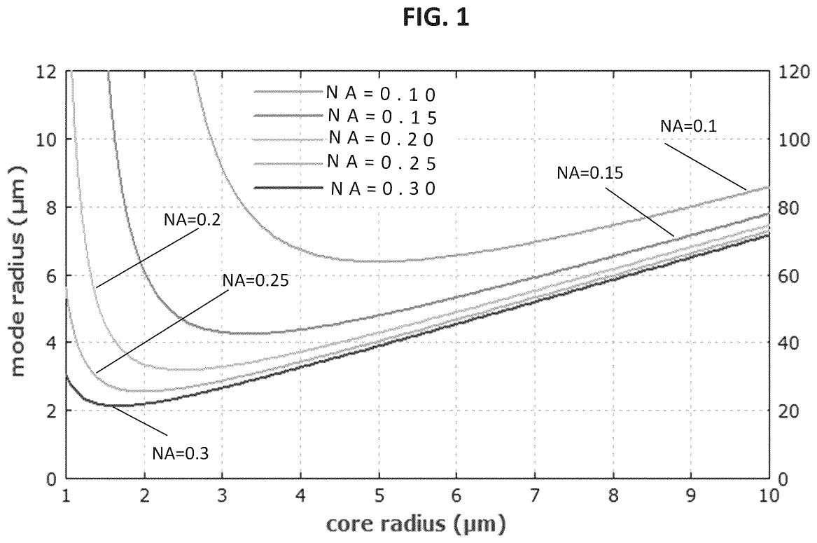

### DETAILED DESCRIPTION

Aspects and features of the present disclosure will now be described more fully with reference to the accompanying drawings. The following description shows, by way of example, combinations and configurations in which aspects, features, and embodiments of inventive concepts can be put into practice. It will be understood that the disclosed aspects, features, and/or embodiments are merely examples, and that one skilled in the art may use other aspects, features, and/or embodiments or make functional and/or structural modifications without departing from the scope of the present disclosure. Moreover, in the drawings, like reference numerals refer to like elements throughout, and the sizes of each of the elements may be exaggerated for clarity and/or conveniences of explanation.

The present disclosure describes embodiments of a fiber optic mode field adaptor (also referred to as a coupler or fiber coupler) which allows efficient coupling of light from an optical fiber (or other source) with first mode field diameter mfd₁ to another optical fiber with a second mode field diameter mfd₂, where the first mode field diameter mfd₁ is different than the second mode field diameter mfd₂. The coupler may be provided for and/or optimized to a single wavelength, or it can operate over a wide wavelength range. The fiber coupler may be based on silica glass material, but could be made from any glass material that transmits in the wavelength region of operation. The mode field adaptor may provide high mechanical strength and/or high-power handling. The mode field adaptor may provide beam cleanup whereby the higher order modes supported by a first fiber are not coupled to the core of a second fiber and can be stripped from the clad of the second fiber. The mode field adapter may reduce/minimize optical nonlinearities which can occur in the coupling region.

The lowest order optical mode for a large mode area fiber will have a mode field diameter at a given wavelength that is independent of the cladding diameter. Three typical fibers according to some embodiments of present inventive concepts may include: fibers with 20 μm core diameter and 0.065 NA; fibers with 25 μm core diameter and 0.065 NA; and fibers with 14 μm core diameter and 0.07 NA. The calculated mode field diameters at 1070 nm for each of these fibers may be 17.9 μm, 21.2 μm, and 13.9 μm, respectively.

Fusion splicing is a process typically used to form strong mechanical joints (e.g., providing >60 g of tension) between optical fibers. Typical fusion splicing is done for fibers with diameters greater than 80 μm. The fiber is cleaved to provide a near flat interface (e.g., angular deviation of the cleave should be less than 1 degree for low power applications and less than 0.2 degree for high power applications). Each fiber to be spliced is aligned to improve/optimize the transmission between the cores. The fiber is heated to soften the cleaved ends, mechanically pushed together and heated again to reflow the glass and provide a strong bond. This process may be difficult/complicated to perform between fibers of dissimilar architectures such as step-index fibers and photonic crystal fibers. The guidance of the photonic crystal fiber may be strongly dependent on the geometrical arrangement of air holes, therefore distortion by heat of the structure can reduce/ruin guidance. To reduce/avoid collapsing holes, “cold splicing” may be used, where the PCF does not get too hot and there is reduced/minimal reflow of material around the junction. This may lead to a weaker junction between fibers with a high sensitivity to torsion, vibration, and/or thermal expansion which can damage the junction.

The mechanical strength of a fusion spliced optical fiber junction (between two fiber interfaces) for solid core optical fibers may be greater than 200 g for fiber(s) with 125 μm diameter. For splices between photonic crystal fibers and solid core fibers, the mechanical strength may typically be less than 60 g. For reference, the tensile strength of as-drawn silica fibers are typically tested to 100 kpsi (0.69 GPa) (approximately 860 g for SMF28e), and higher numbers 725 kpsi to 870 kpsi (5 GPa to 6 GPa) may be possible (Reference [3]: M. John Matthewson, Optical Fiber Reliability Models, SPIE Fiber Optics Reliability and Testing, Critical Reviews of Optical Science and Technology, Vol. CR50, pages 3-31, 1993).

The wavelength of a laser is assumed to be within the transmission band of the silica optical fiber, for example, in the range of about 300 nm to about 2400 nm. The laser emission can be single wavelength or cover a broadband of wavelengths. Example laser systems that could be used include but are not limited to Ytterbium doped fiber-based lasers and/or amplifiers, Thulium doped fiber-based lasers and/or amplifiers, Er:Yb fiber-based lasers and/or amplifiers, and/or Ho doped fiber-based lasers and/or amplifiers.

A high-power laser is defined herein as a laser with a peak power in the range of about 10 W to about 100 kW, and more particularly in the range of about 100 W to about 10 kW, and average powers in the range of about 1 W to about 10 kW.

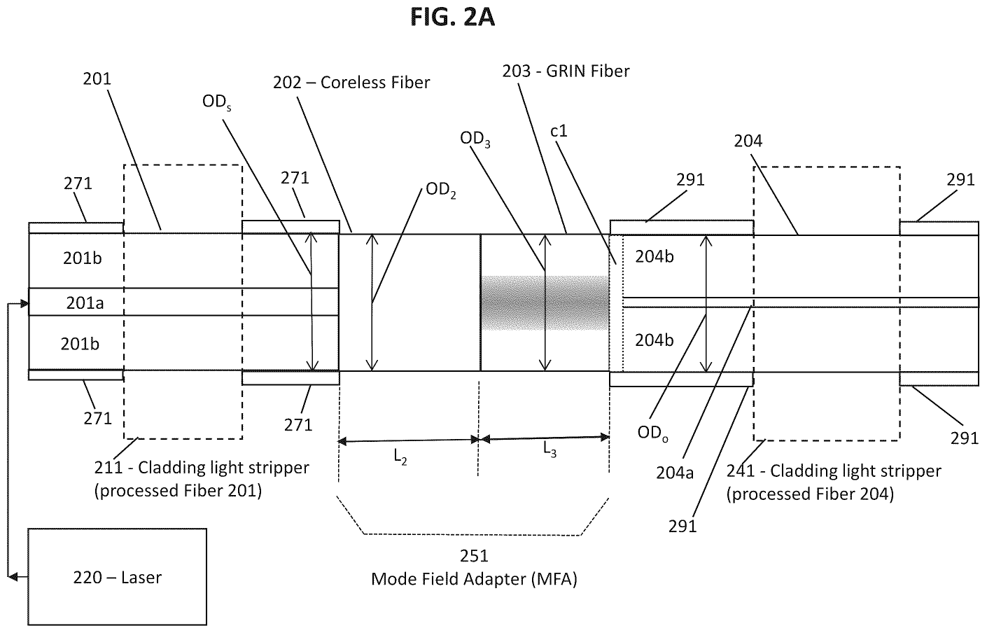

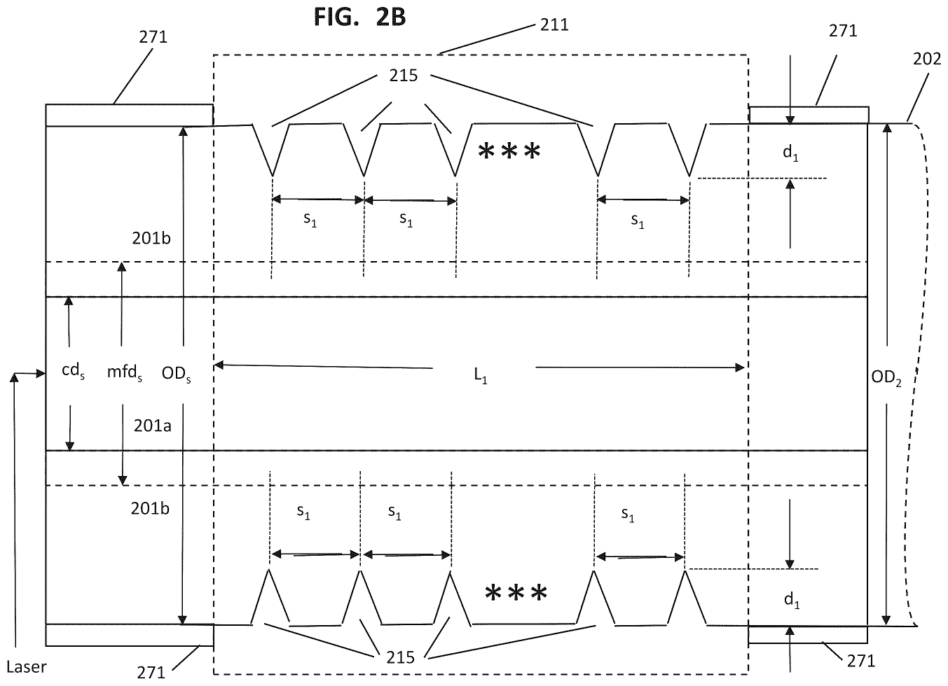

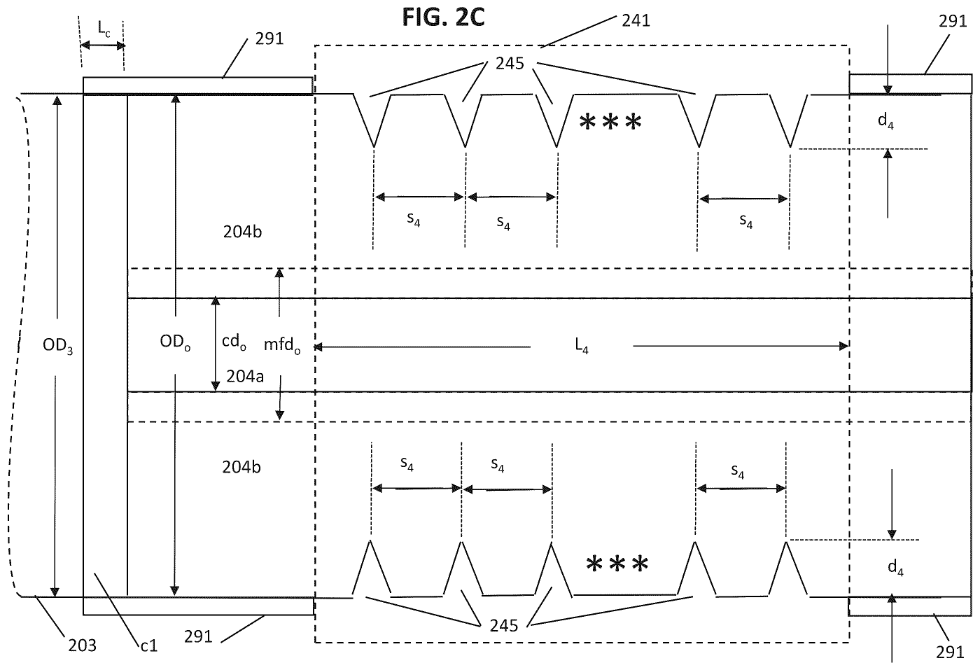

The present disclosure describes embodiments of a mode field adaptor that may be provided between two dissimilar mode area fibers. In an example embodiment illustrated in FIG. 2A, coupling is between a large mode area input fiber 201 (also referred to as an optical source fiber) and a smaller mode area output fiber 204 (also referred to as an output fiber). Due to the reciprocity of light, equal coupling may be obtained in the reverse direction, from the smaller mode area fiber 204 to the larger mode area fiber 201. In some embodiments of inventive concepts, light from two dissimilar mode area fibers 201 and 204 can be converted and coupled through a mechanically strong all-fiber connection including coreless fiber 202 and graded-index (GRIN) optical fiber 203. In some embodiments, a device may be based on imaging the mode of input fiber 201 into output fiber 204 at a finite distance. In such embodiments, the optical mode of input fiber 201 diverges into coreless optical fiber 202 (e.g., a glass rod having a uniform index of refraction over its full cross-sectional area), is then refocused by GRIN fiber 203, and then propagates through a small length of solid glass c1 prior to refocusing inside output fiber 204. In the case where output fiber 204 is a photonic crystal fiber (PCF) or a hollow core fiber (HCF), the PCF or HCF may be collapsed at the attachment of GRIN fiber 203 to form a solid glass region to improve/optimize the coupling to the core. This collapsed region may offer the advantages of a stronger bond than that which may be typical for PCF or HCF splicing to conventional mode field adapters (MFAs).

Note that more than one GRIN fiber may be inserted between the two dissimilar mode input and output fibers 201 and 204 to achieve improved/optimum coupling. Stated in other words, GRIN fiber 203 may include two or more GRIN fibers each having a graded index of refraction that is different than the other GRIN fibers. Moreover, additional optical elements (either active or passive) may be inserted between the multiple GRIN fibers, between input fiber 201 and coreless fiber 202, between coreless fiber 202 and GRIN fiber 203, and/or between GRIN fiber 203 and output fiber 204. Examples of these elements may include filters, volume Bragg gratings, nonlinear crystals, absorptive materials, laser gain materials, etc.

Optically active materials such as laser gain crystals can have very large dopant concentrations enabling pump absorption to occur over very short lengths (on the order of 1 cm). The use of a short active gain element inside a cavity may enable short laser cavities used/required for single frequency (e.g., <10 MHz spectral linewidth) lasers. Additionally, the use of crystalline elements for the laser gain may narrow the emission bandwidth further restricting the allowed modes that overlap the free spectral range of the laser cavity. The use of short crystals with low phonon energies may allow for emission at wavelengths that may otherwise be suppressed in glass materials such as silica.

The present disclosure also describes embodiments of methods to reduce/minimize dispersion and/or nonlinearities in the light coupled between two dissimilar fibers 201 and 204 using the GRIN mode field adapter approach. In some mode field adapters coupling from a larger mode area fiber to a smaller mode area fiber, concatenated fiber sections decreasing in mode field diameter may be used to efficiently couple the fibers from the larger mode area to the smaller mode area. These fiber sections may be fusion spliced together to form a mode field adapter. Due to limitations in fusion splicing and assembly, these concatenated mode field adapters may have lengths in the range of about 1 cm to about 15 cm. High intensity light traveling from the large mode area input fiber through the decreasing mode field area mode field adapter can result in nonlinear interactions with the fiber medium resulting in broadening of the light spectrum and/or change in the temporal dispersion of the light (pulse compression or broadening) which can be detrimental for some applications. In contrast, in the GRIN mode field adapter according to some embodiments of inventive concepts, the light diverges from the input fiber/source and then is reimaged in the GRIN fiber section near the spliced PCF, reducing/minimizing any spectral and/or temporal broadening and/or distortion of the input light.

The B-integral is a measure of the nonlinear phase shift accumulated by a light beam as it propagates in a medium. It can be used to provide relevant lengths for which the spectrum of the light will be distorted by nonlinearities. The B-integral is defined by:

$$B = \frac{2 π}{λ} \int \frac{{n}_{2} P ( z )}{Aeff ( x )} dz \qquad Equation [ 4 ]$$

Where n₂ is the nonlinear refractive index (approximately 2.6×10⁻²⁰ m²/W for silica), λ is the wavelength of light, P(z) is the peak power of the light at a position z along the fiber, and A_{eff} is the effective area at position z along the fiber.

If a constant diameter fiber with a fixed peak power beam propagating is assumed, the characteristic nonlinear length (Lₙₗ) can be estimated where the phase accumulated (calculated by the B integral) is 1. To reduce/avoid nonlinearities in a system, it is common to use L<<Lₙₗ, with a typical reference value of L<Lₙₗ/10.

Values for Lₙₗ can be estimated for different fiber diameters. For example, assuming λ to be 1 μm (10⁻⁶ m), utilizing the n₂ value for silica, and approximating the effective area A_{eff}=Pi*(radius of the core of the fiber in microns)²*10⁻¹², then

$${L}_{nl} = {( radius in microns )}^{2} / ( 5.2 * {10}^{- 2} * Power in watts ) . \qquad Equation [ 5 ]$$

Accordingly, using Equation (5) for different values of Power P and core diameter (divided by 2 to obtain the core radius), Lₙₗ can be calculated as follows:

$$P = 1 kW , 5 μ m core diameter = \text{>} L = ( {2.5}^{2} / 52 ) [ m ] = 12 cm$$

$$P = 2 kW , 5 μ m core diameter = \text{>} L = ( {2.5}^{2} / 104 ) [ m ] = 6 cm$$

$$P = 2 kW , 4 μ m core diameter = \text{>} L = ( {2}^{2} / 104 ) [ m ] = 4 cm$$

Typical lengths used/required to taper a large mode area fiber with low numerical aperture (such as a 25 μm core, 0.065 NA fiber) down to smaller diameters with low loss may be on the order of 10 mm. Therefore, tapering as a method to adjust mode field adaptors may inherently induce significant nonlinear phases on the light, as the lengths used/needed may exceed Lₙₗ/10.

Meanwhile, approaches according to some embodiments of inventive concepts may lead to typical lengths in the range of about 0.3 mm to about 5 mm, with the beam mode increasing in effective area over a significant part of the length, and therefore can satisfy the condition for L<Lₙₗ/10.

More specifically, in embodiments that use a photonic crystal fiber (PCF) (such as nonlinear conversion by four wave mixing, parametric amplification, or supercontinuum generation), the broadening and distortion of the incoming field can result in reduced efficiency of the nonlinear process. In particular, for four wave mixing, Raman scattering generated in the mode field adapter section can result in seeding of Raman gain in the PCF which may compete with and/or reduce the efficiency of the four wave mixing process in the photonic crystal fiber.

Optical fiber mode field adaptors (MFAs) described herein according to some embodiments of inventive concepts can efficiently convert the optical mode field diameter (MFD) between mode field diameter mfd₁ of optical fiber 201 (or other source) and mode field diameter mfd₄ of optical fiber 204 by imaging the optical field of fiber 201 into fiber 204 at a given propagation distance (or by imaging the optical field of fiber 204 into fiber 201 at the given propagation distance). One such embodiment is conceptually illustrated in FIGS. 2A, 2B, and 2C. FIG. 2A illustrates fiber 201, mode field adapter 251 (including coreless fiber 202 and GRIN fiber 203), and fiber 204. FIG. 2B illustrates an expanded view of fiber 201 and a portion of coreless fiber 202. FIG. 2C illustrates an expanded view of fiber 204 and a portion of GRIN fiber 203.

In FIG. 2A, mode field adaptor 251 includes coreless fiber 202 (also referred to as a coreless optical fiber) having outer diameter OD₂ and length L₂ and graded index GRIN fiber 203 (also referred to as a GRIN optical fiber) having outer diameter OD₃ and length L₃, with coreless and GRIN fibers 202 and 203 between fibers 201 and 204. As used herein, the term coreless fiber means that a refractive index of the coreless fiber remains substantially constant across a full diameter of the coreless fiber (i.e., the refractive index remains substantially constant at each radial distance from the optical axis of the fiber to the outer circumference thereof). As used herein, the term GRIN fiber means that a refractive index of the GRIN fiber changes (e.g., decreases) continuously with increasing radial distance from the optical axis of the optical fiber.

As shown in FIGS. 2A and 2B, fiber 201 may include inner core 201a with core diameter cdₛ and outer cladding 201b with outer diameter ODₛ, and fiber 201 may have a mode field diameter mfdₛ defined as discussed above with respect to Equations (2a) and (2b) based on core diameter cdₛ, outer diameter ODₛ, and the refractive indices of inner core 201a and outer cladding 201b. In addition, protective coating 271 (e.g., a protective polymer coating), may be provided on fiber 201, and portions of protective coating 271 may be removed to provide cladding light stripper 211 as discussed in greater detail below.

As shown in FIGS. 2A and 2C according to some embodiments of inventive concepts, fiber 204 may include inner core 204a with core diameter cdₒ and outer cladding 204b with outer diameter ODₒ according to some embodiments, and fiber 204 may have a mode field diameter mfd₄ defined as discussed above with respect to Equations (2a) and (2b) based on core diameter cdₒ, outer diameter ODₒ, and the refractive indices of inner core 204a and outer cladding 204b. According to some other embodiments of inventive concepts, fiber 204 may be a PCF having mode field diameter mdf₄. In addition, protective coating 291 (e.g., a protective polymer coating), may be provided on fiber 204, and portions of protective coating 291 may be removed to provide cladding light stripper 241 as discussed in greater detail below.

Mode field diameters mfdₛ and mfdₒ of source fiber 201 (also referred to as an input fiber) and output fiber 204 are different. According to some embodiments, mode field diameter mfdₛ of fiber 201 may be in the range of about 14 μm to about 20 μm, and mode field diameter mfdₒ of fiber 204 may be in the range of about 1 μm to about 5 μm. Accordingly, mode field diameter mfdₛ of fiber 201 may be in the range of about 3 times to about 20 times greater than mode field diameter mfdₒ of fiber 204. In embodiments of FIGS. 2A-C where laser 220 is coupled with fiber 201 having the greater mode field diameter (i.e., mfdₛ>mfdₒ), light is coupled through fiber 201, coreless fiber 202, GRIN fiber 203, and then into fiber 204 having the smaller mode field diameter mfdₒ. In some other embodiments of inventive concepts, the laser may be coupled with fiber 204 having the smaller mode field diameter mfdₒ (such that light enters fiber 204 from the right side of FIG. 2A and exits fiber 201 on the left side of FIG. 2A), and in such embodiments, light is coupled through fiber 204, GRIN fiber 203, coreless fiber 202, and then into fiber 201 having the larger mode field diameter mfdₛ. Accordingly, mode field adapter (MFA) 251 may be used to adapt light in either direction between fiber 201 and fiber 204 (i.e., from greater to lesser mode field diameter as shown in FIG. 2A or from lesser to greater mode field diameter). In either case, however, MFA 251 is arranged with coreless fiber 202 between GRIN fiber 203 and the fiber 201 having the greater mode field diameter mfdₛ and with GRIN fiber 203 between coreless fiber 202 and the fiber 204 having the lesser mode field diameter mfdₒ. Stated in other words, MFA 251 of FIG. 2A may be used bidirectionally.

As shown in greater detail in FIG. 2B, protective layer 271 may be removed from cladding light stripper 211 portion of fiber 201, and a series/array of notches 215 having depth d₁ may be provided in outer cladding 201b spaced apart by a distance s₁ along a length L₁ (in an axial direction of fiber 201) to scatter light that is carried in cladding 201b. According to some embodiments, notches 215 may be provided circumferentially around cladding 201b, longitudinally in parallel with an axial direction of fiber 201, as an array of dots, as partial spirals, etc.

As shown in greater detail in FIG. 2C, protective layer 291 may be removed from cladding light stripper 241 portion of fiber 204, and a series/array of notches 245 having depth d₄ may be provided in outer cladding 204b spaced apart by a distance s₄ along a length L₄ (in an axial direction of fiber 204) to scatter light that is carried in cladding 204b. According to some embodiments, notches 245 may be provided circumferentially around cladding 204b, longitudinally in parallel with an axial direction of fiber 204, as an array of dots, as partial spirals, etc.

In embodiments of FIG. 2A, laser 220 may be coupled with (e.g., spliced to) fiber 201, and light laser 220 may propagate through fiber 201 according to mode field diameter mfdₛ. Light from fiber 201 may thus be coupled through mode field adapter 251 to fiber 204 such that the light propagates through fiber 204 according to mode field diameter mfdₒ. In such embodiments, fiber 201 may be referred to as an input/source fiber and fiber 204 may be referred to as an output fiber. According to some alternative embodiments, a laser may be coupled with (e.g., spliced to) fiber 204, and light from the laser may propagate through fiber 204 according to mode field diameter mfdₒ. In such alternative embodiments, light from fiber 204 may thus be coupled through mode field adapter 251 to fiber 201 such that the light propagates through fiber 201 according to mode field diameter mfdₛ. In such embodiments, fiber 204 may be referred to as an input/source fiber, fiber 201 may be referred to as an output fiber, and the laser and fiber 204 may be collectively referred to as a light source.

In embodiments illustrated in FIGS. 2A-C for a given wavelength λ, light propagates with mode field diameter mfdₛ inside fiber 201 with outer diameter ODₛ. Implementation of the mode field adaptor (MFA) 251 (including coreless fiber 202 and GRIN fiber 203) may use/require a splice between fiber 201 and laser 220. As used herein, the term light source may refer to a combination of laser 220 and fiber 201. Any light that is not well coupled into fiber 201 due to the splice or any leftover light guided in the cladding of fiber 201 may need to be properly removed prior to imaging the light from fiber 201 through MFA 251 to fiber 204 (which may be a photonic crystal fiber), for example, using cladding light stripper 211 as shown in greater detail in FIG. 2B.

Fiber 201 may have protective coating 271 (e.g., a polymer protective coating) on an outer surface thereof, and portions of protective coating 271 may be removed over a length L₁ (e.g., in the range of about 150 mm to about 300 mm). Cladding light stripper 211 may be provided by inscribing a series of notches 215 (e.g., using a CO₂ laser) on outer cladding 201b of fiber 201 to scatter any light that is carried in cladding 201b out of fiber 201. Notches 215 may have depth d₁ at spacing of s₁ along a portion of length L₁. Dimensions for the notch depth d₁ may be in the range of about 10 μm to about 50 μm, spacings s₁ between notches (also referred to as pitches) may be in the range of about 0.25 mm to about 4 mm, and notch lengths may be in the range of about 25 mm to about 150 mm (e.g., about 100 mm). The notched area of cladding light stripper 211 may be located approximately 25 mm from the end of fiber 201 adjacent to coreless fiber 201. According to some embodiments, notches 215 may be provided along the fiber propagation direction (i.e., along an axial direction of fiber 201) as a series of notches made along the 360 angle of the fiber.

Fiber 202 may be a coreless fiber (e.g., a silica glass rod/fiber) that has outer diameter OD₂ matched to outer diameter ODₛ of fiber 2011. Fiber 202 may be spliced to fiber 201 and cleaved to length L₂ determined by a desired/required imaging ratio between mode field diameter mfdₛ and mode field diameter mfdₒ of fiber 204 (e.g., a target photonic crystal fiber). Fiber 203 may be a graded index (GRIN) fiber. Outer diameter OD₃ of Fiber 3 may ideally match that of fiber 201, but outer diameter OD₃ of GRIN fiber 203 may be limited, for example, to 125 μm. Fiber 203 may be spliced to fiber 202 and cleaved to length L₃ determined by the imaging desired/required. Lengths L₂ and L₃ for respective fibers 202 and 203 may be correlated to and/or determined by the imaging desired/required.

Fiber 204 may be a photonic crystal fiber with mode field diameter mfdₒ at wavelength λ. Fiber 204 may be prepared by adding cladding light stripper 204 similar to cladding light stripper 211 discussed above with respect to fiber 201 (first exposing cladding 204b by removing portions of protective polymer coating 291 over length L₄), but with dimensions of notch depth d₄, spacing s₄, and notch length determined by outer diameter ODₒ of Fiber 204. Values of outer diameter ODₒ may be in the range of about 125 μm and about 400 μm (e.g., in the range of about 250 μm to about 400 μm). Examples of values for depth d₄, spacing s₄ and notch length may be 30 μm, 1 mm, and 100 mm, respectively. Fiber 204 (e.g., a photonic crystal fiber) may be exposed to heat to collapse the internal structure at a distance of approximately 25 mm from an end of the notched area. Fiber 204 is then cleaved at the collapsed area leaving a length Lₑ of fully collapsed fiber region c1. Length Lₑ of fully collapsed fiber c1 may be determined by the imaging combination. Fiber 204 (e.g., photonic crystal fiber) may be spliced to fiber 203 at a sufficiently high temperature to provide a mechanically strong joint. For example, a strength of the joint between fibers 203 and 204 may be in the range of about 100 g to about 500 g of tension. Fully collapsed fiber region c1 may be considered as a part of fiber 204, or fully collapsed fiber region c1 may be considered as a separate element between fibers 203 and 204.

Dimensions of MFA 251 may be determined based on mode field diameters mfdₛ and mfdₒ. In an embodiment with fiber 1 having a 25 μm core diameter cdₛ, a 250 μm outer diameter ODₛ, and a 0.065 numerical aperture (NA), with fiber 204 having a mode field diameter mfdₒ of 4.9 μm, and with fiber 3 being a graded index fiber with a core diameter of 62.5 μm, 125 μm cladding diameter (also referred to as outer diameter), and 0.29 NA, length L₂ of fiber 202 may be in the range of about 250 μm to about 350 μm, length L₃ of Fiber 203 may be in the range of about 250 μm to about 350 μm, and a length Lₑ of collapsed fiber region c1 may be in the range of about 20 μm to about 100 μm.

In embodiments disclosed herein, an all-fiber spliced imaging mode field adapter may thus be provided. In FIG. 2A, for example, coreless fiber 202 and GRIN fiber 203 may be joined by fusion splicing, input fiber 201 and coreless fiber 202 may be joined by fusion splicing, and GRIN fiber 203 and output fiber 204 may be joined by fusion splicing. In other embodiments (e.g., adapting from a smaller mode field diameter input fiber to a larger mode field diameter output fiber), the coreless fiber 202 and output fiber 204 may be joined by fusion splicing, and GRIN fiber 203 and input fiber 201 may be joined by fusion splicing.

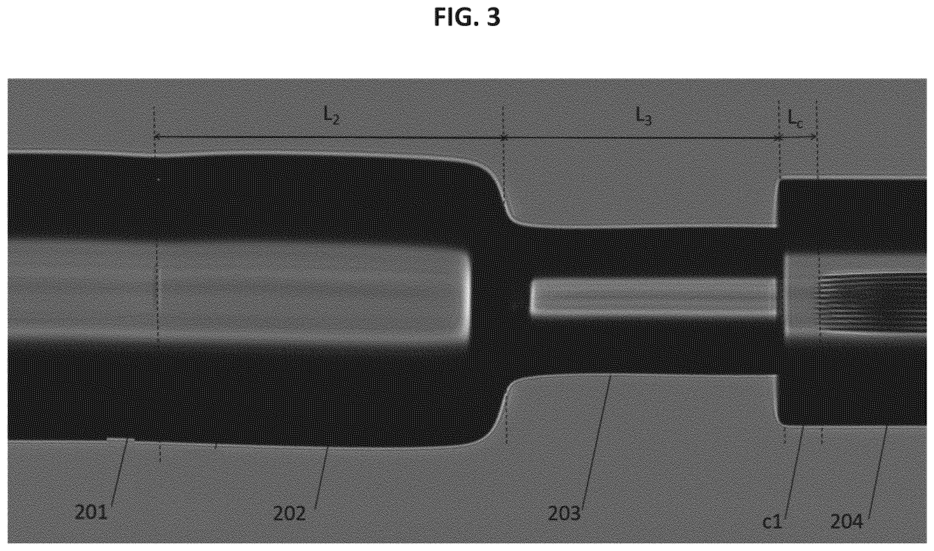

FIG. 3 is a photograph illustrating a side view of MFA 251 of FIGS. 2A, 2B, and 2C including an end portion of fiber 201, coreless fiber 202, GRIN fiber 203, and an end portion of fiber 204 with junctions between fibers 201 and 202, between fibers 202 and 203, and between fibers 203 and 204 joined by splicing.

FIG. 3 illustrates a zoomed in view of an example of a mode field imaging area showing fiber 201 (large mode area 25 μm core, 250 μm cladding, 0.065 NA, LMA-GDF-25/250), fiber 202 (coreless 250 μm fused silica rod), fiber 203 (graded index 50 μm core, 125 cladding, 0.29 NA), and fiber 204 (custom photonic crystal fiber with 4.9 μm core, 170 μm cladding). The system of FIG. 3 demonstrates a mode field reduction of 4.3 times, with over 84% transmission. The input side of fiber 201 has a 10 mm length cladding mode stripper 211 including 19.5 μm deep notches 215 on fiber 201. The output side of fiber 204 has 40 mm length cladding mode stripper 241 including 18 μm deep notches 245 on fiber 204. The mode field of FIG. 3 was tested up to 750 W continuous wave and 5 kW peak power with no failure.

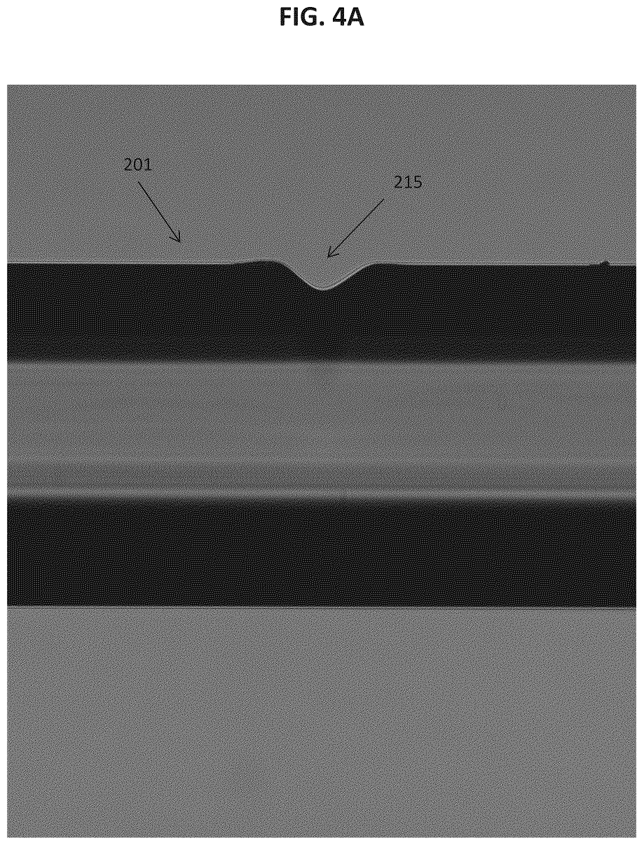

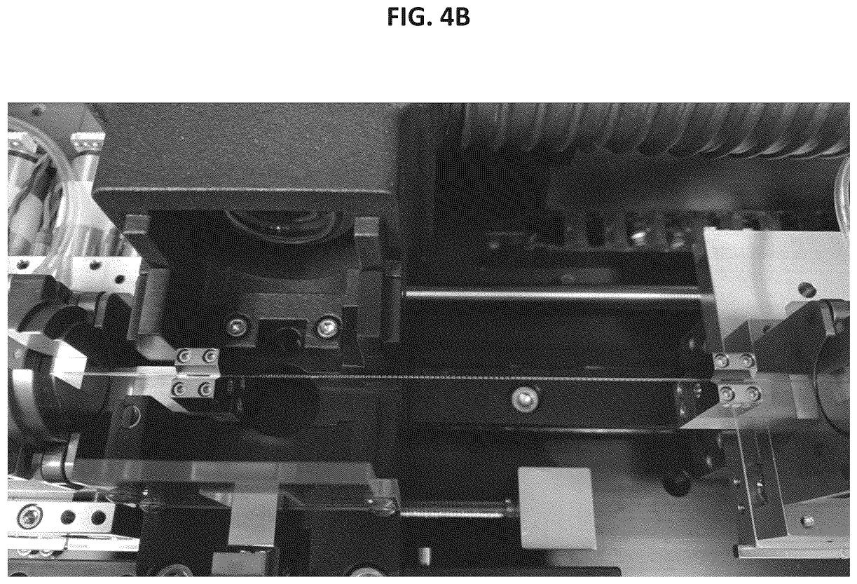

FIG. 4A illustrates a cross section of an embodiment of a notch 215 on Fiber 201. In the embodiment of FIG. 4A, the notch depth d₁ is 19.5 μm, and the fiber outer diameter ODₛ is 250 μm. FIG. 4B illustrates a 100 mm long notch 215 on fiber 201 having a 400 μm outer diameter ODₛ.

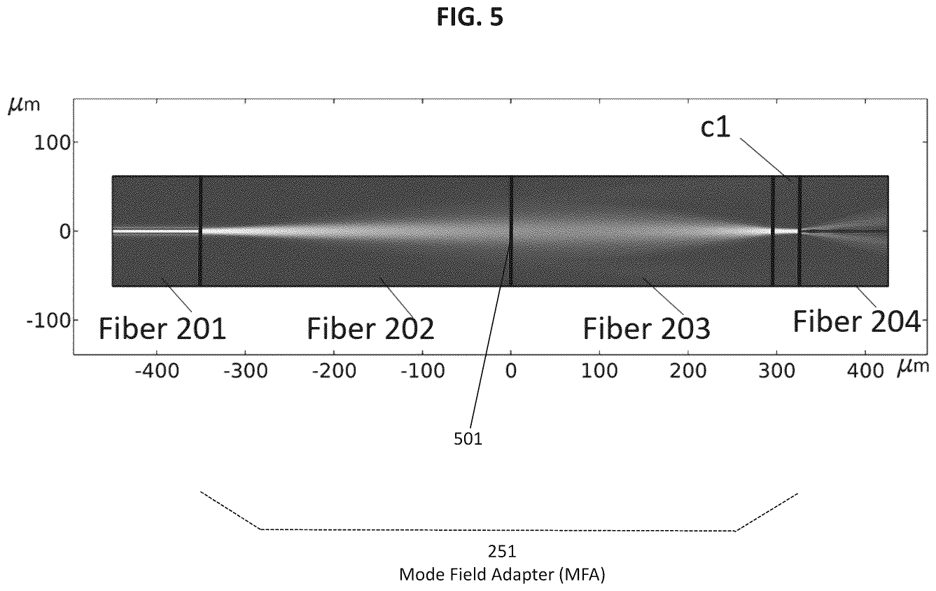

FIG. 5 illustrates a two dimensional cut out along the propagation direction of an optical field intensity modelled by a beam propagation method using COMSOL software. FIG. 5 shows the beam propagating in Fiber 201, diverging in Fiber 202, refocusing in Fiber 203, and coupling back to Fiber 204. The lengths of the fibers are indicated relative to the splicing joint 501 between Fiber 202 to Fiber 203.

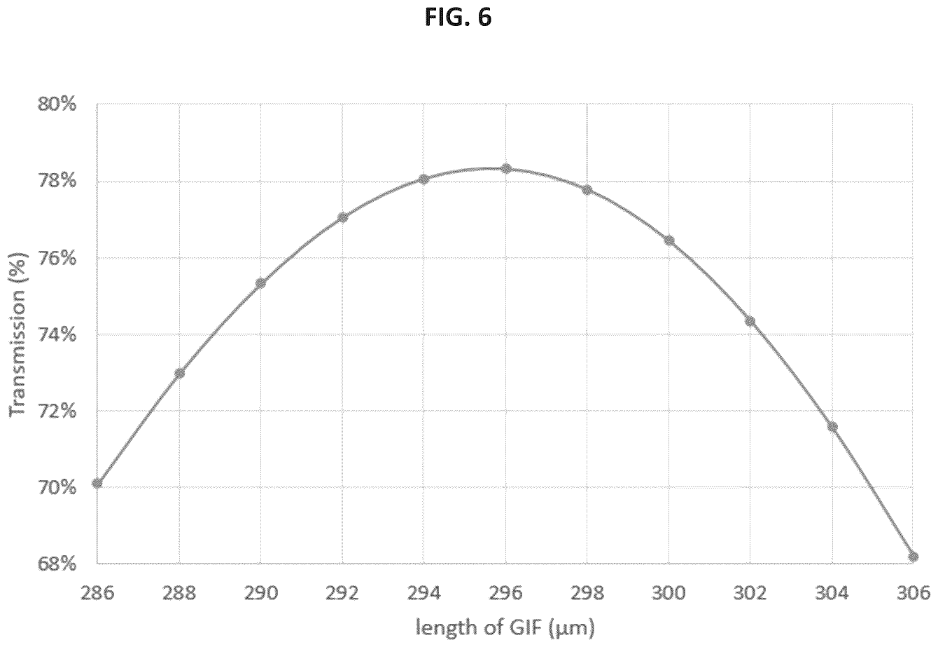

FIG. 6 illustrates an example of the sensitivity of the transmission across a one mode field adapter for a given graded index fiber length.

In FIG. 6, transmission for the scenario shown in FIG. 5 is modeled as a function of different values for the length of the graded index fiber (GIF) (Fiber 203).

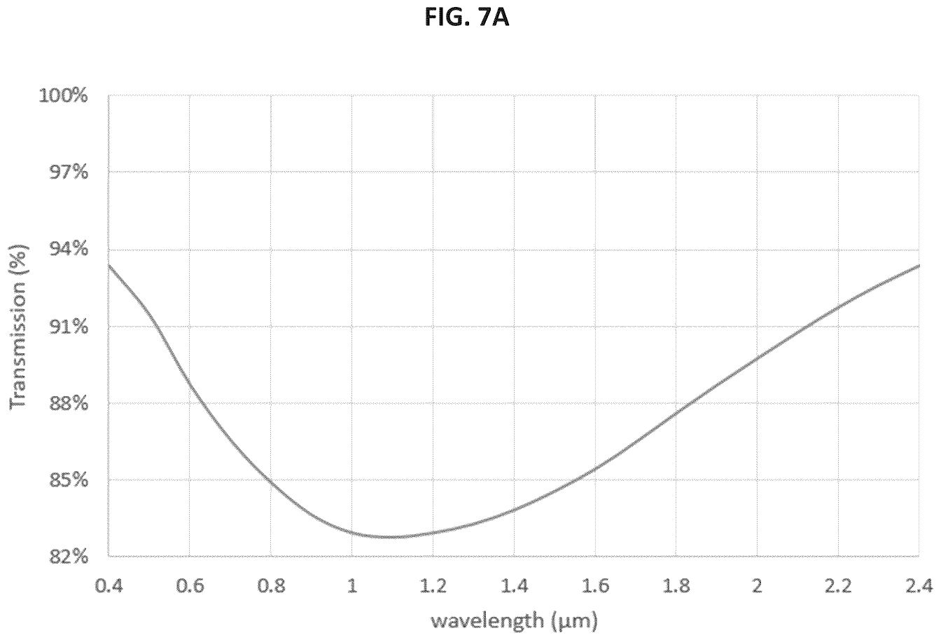

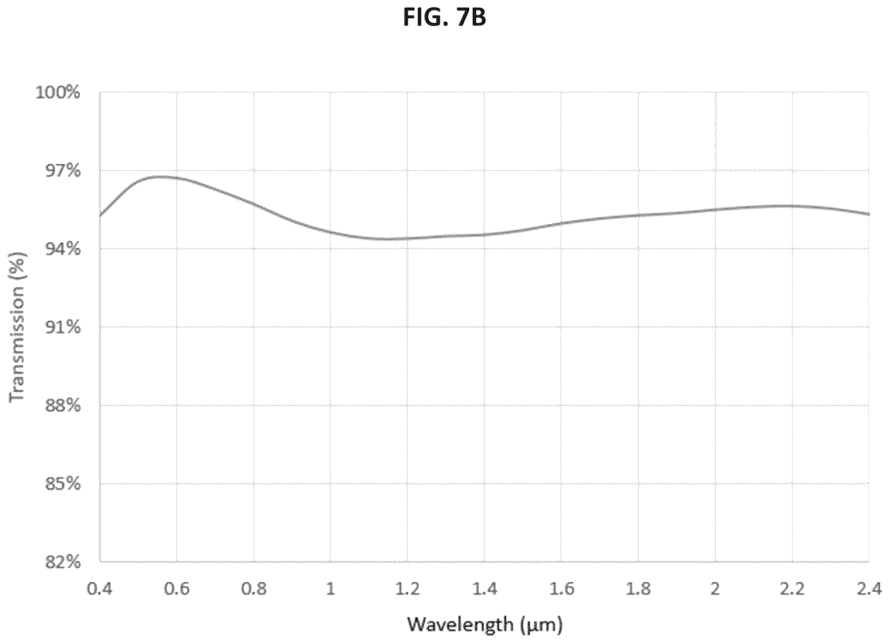

FIGS. 7A and 7B illustrate the impact of broadband wavelength transmission of an approach described according to some embodiments of inventive concepts. The mode field adapter transmission (shown on the y-axis of FIGS. 7A and 7B) is calculated for the case of a 20 μm core diameter fiber 201 with NA 0.065 being coupled to fiber 204 with core 3.8 μm and NA 0.2. The GRIN fiber 203 is 62.5 μm in core diameter with NA 0.29. The collapse region c1 is fixed at 30 μm, and two cases for the coreless region 202 are respectively shown in FIG. 7A (with coreless region 202 having a length L₂ of about 300 μm) and FIG. 7B (with coreless region 202 having a length L₂ of about 900 μm length). For both modelled scenarios the absolute transmission does not vary by more than 10%.

FIGS. 7A and 7B respectively illustrate absolute transmission for different designs of the mode field adaptor showing the broadband wavelength nature of the design. The absolute transmission varies by 10% across the whole transmission range for the design of FIG. 7A, and less than 5% for the design of FIG. 7B.

According to some embodiments of inventive concepts, Fiber 202 is a photonic crystal fiber with single mode propagation at the optical design wavelength. Fiber 201 is low order mode fiber, with less than 8 modes (for a given polarization), more typically less than 6 modes.

The following examples illustrate some embodiments of inventive concepts.

According to Example 1 provided according to the structure of FIGS. 2A, 2B, and 2C, fiber 201 is provided as a double clad optical fiber with core diameter cdₛ of 25 μm, a numerical aperture of 0.065, and an outer diameter ODₛ of 250 μm. Protective polymer coating 271 is stripped over a length L₁ of about 150 mm, and a CO₂ laser is focused on the exposed portion of fiber 201 to form a series of notches 215 having 20 μm depth d₁ along 100 mm of the exposed fiber with a period of 1 mm. Fiber 201 is rotated by 120 degrees and notched again along the same 100 mm length and 1 mm period. The fiber is rotated a second time by 120 degrees and notched another time with the same 100 mm length and 1 mm period. Coreless fiber 202 having outer diameter OD₂ of 250 μm is made of fused silica, and fiber 202 is spliced to the end of the notched tail of fiber 201 and cleaved to span a length L₂ of 300 μm. Graded index fiber 203 with a 62.5 μm core and a 125 μm clad is aligned and spliced to coreless fiber 202 and cleaved to a length L₃ of 250 μm.

In Example 1, fiber 204 is a photonic crystal fiber with mode field diameter mfdₒ of 4.9 μm (at a wavelength of 1070 nm) and outer diameter ODₒ of 180 μm, and cladding 204b is stripped of protective polymer coating 291 over a length L₄ of 150 mm. The same notching process discussed above with respect to notches 215 of Example 1 is replicated in the photonic crystal fiber to provide notches 245, resulting in cladding light stripper 241 of 100 mm length. The photonic crystal fiber is exposed to high temperature to collapse the holes in the fiber about 25 mm away from the cladding light stripper in the direction opposite to the polymer coating. The fiber is cleaved leaving a collapsed region c1 with a length L_{c} of 25 μm from the uncollapsed hole region. The photonic crystal fiber is actively aligned to the output of graded index fiber 203, and the photonic crystal fiber (fiber 204) and graded index fiber 203 are spliced together. Because region c1 of the photonic crystal fiber is already collapsed, high temperature can be locally applied to the splice without significant distortion of the hole structure. Once fibers 203 and 204 are mechanically joined by the splice, throughput power may be improved/optimized by increasingly heating of fiber 204 and monitoring the transmission. The hole collapse area c1 may have a length Lₑ of about 30 μm after such improvement/optimization. The device including fibers 201, 202, 203, and 204 may be mounted in a metal enclosure to block any scattering light without direct contact on the cladding strippers or in the area between the cladding strippers. This mode field adaptor shows 4.3 times mode field reduction and power handling of 3 kW average power.

According to Example 2 provided according to the structure of FIGS. 2A, 2B, and 2C, the device of Example 1 may be provided such that outer diameter ODₛ of fiber 201 is 400 μm, and outer diameter OD₂ of Fiber 202 is 400 μm.

According to Example 3 provided according to the structure of FIGS. 2A, 2B, and 2C, the device of Example 2 may be provided with Fiber 201 having core diameter cdₛ of 20 μm. Length L₂ of Fiber 202 is 800 μm, and length L₃ of Fiber 203 is 250 μm.

According to Example 4 provided according to the structure of FIGS. 2A, 2B, and 2C, the device of Example 1 may be provided with Fiber 201 having core diameter cdₛ of 14 μm. Length L₂ of Fiber 202 is 650 μm, and length L₃ of Fiber 203 is 260 μm.

According to Example 5, mode field adaptor 251 may provide nonlinear frequency conversion such as four-wave mixing and/or parametric amplification where a pump laser has a narrow frequency (e.g., <10 nm spectral linewidth) centered at a wavelength of 1070 nm with a double clad laser output optical fiber 201 with core diameter cdₛ of 20 μm, numerical aperture of 0.065, and with outer diameter ODₛ of 400 μm. Laser output fiber 201 is stripped of protective polymer coating 271 over length L₁ of about 150 mm. A CO₂ laser is focused on the exposed portion of fiber 201 to form a series of notches 215 of 20 μm depth d₁ along 100 mm of the exposed portion of fiber 201 with a period of 1 mm. Fiber 201 is rotated by 120 degrees and notched again along the same 100 mm length. Fiber 201 is rotated a second time by 120 degrees and notched another time. Coreless fiber 202 is made of fused silica with outer diameter OD₂ of 400 μm and is spliced to the end of the notched tail and cleaved to span a length L₂ of 500 μm. Graded index fiber 203 with 62.5 μm core diameter and 0.275 numerical aperture is aligned and spliced to coreless fiber 202 and cleaved to a length L₃ of 250 μm.

In Example 5, fiber 204 is a photonic crystal fiber with mode field diameter mfdₒ of 4.9 μm at a wavelength of 1070 nm and fiber 204 is stripped of any polymer over a length L₄ of 150 mm. The same notching process as discussed above with respect to fiber 201 of Example 5 is replicated in the photonic crystal fiber, resulting in a cladding light stripper 241 of 100 mm length. The photonic crystal fiber is exposed to high temperature to collapse the holes in fiber 204 about 25 mm away from the cladding light stripper 241 in the direction opposite to the polymer coating. Fiber 204 is cleaved leaving a collapsed region having a length L_{c} of 25 μm from the uncollapsed hole region. The photonic crystal fiber is actively aligned to the output of graded index fiber 203 and the two are spliced together. Because an end portion of the photonic crystal fiber is already collapsed, high temperature can be locally applied to the splice without significant distortion of the hole structure. Once fiber 204 is mechanically joined with fiber 203 by the splice, throughput power may be improved/optimized by increasingly heating the fiber and monitoring the transmission. The hole collapse area c1 may be about 30 μm after improvement/optimization.

The resulting device of Example 5 may be mounted in a metal enclosure to block scattering light without direct contact on the cladding strippers 211 and 241 or in the area between the cladding strippers 211 and 241. The mode field adaptor 251 of Example 5 shows 3.7 times mode field reduction and power handling of 3 kW average power. The optical path length through which the pump laser light propagates before reaching the input of the PCF (fiber 204) is less than 1 mm. The mode field diameter of the light remains above the mode field diameter of the output fiber for the coreless region further reducing nonlinear phase accumulated over mode field adaptor 251. The impact of the relatively short mode field adaptor 251 is to reduce/avoid broadening of the laser pump, to reduce/minimize the Raman total gain, and to provide a spectrally clean pump to the photonic crystal fiber.

According to Example 6, mode field adapter 251 of example 5 is connected to a similar photonic crystal fiber (fiber 204) with input mode field diameter mfd₄ of 4.9 μm at a wavelength of 1070 nm. Here, the photonic crystal fiber is structured so that the pump is near or in the anomalous dispersion region of the fiber to enable broadband supercontinuum generation. The relatively short mode field adapter 251 reduces/minimizes broadening of the laser pump and Raman to enhance supercontinuum generation in the lower wavelength regions of the supercontinuum spectrum.

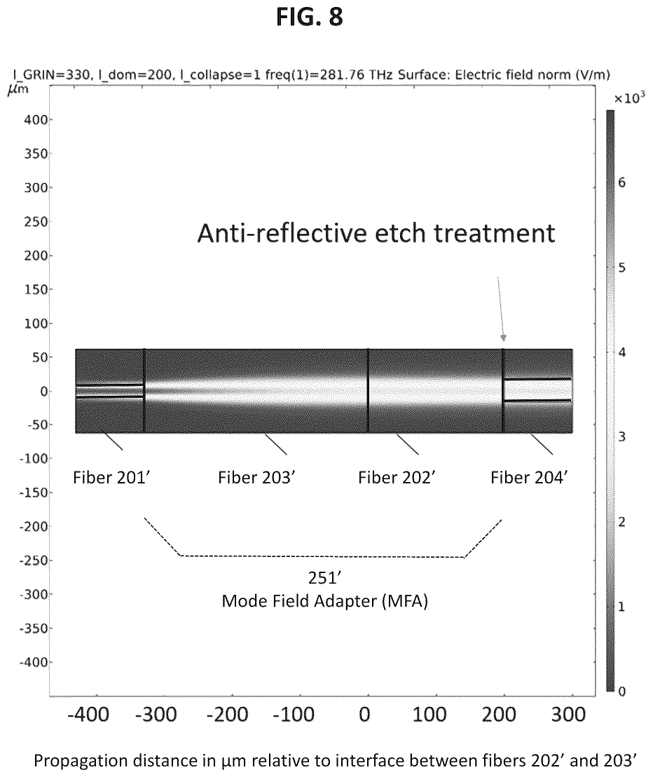

In Examples 1-6 discussed above, mode field adapter 251 may be provided to adapt light from a fiber 201 having a relatively large mode field diameter mfdₛ to a fiber 204 having a relatively small mode field diameter mfdₒ(i.e., mfdₛ>mfdₒ). In such embodiments, coreless fiber 202 is between graded index fiber 203 and fiber 201, and graded index fiber 203 is between coreless fiber 202 and fiber 204. According to some other embodiments, mode field adapter 251 may be provided to adapt light from a fiber 201 having a relative small mode field diameter mfdₛ to a fiber 204 having a relatively large mode field diameter mfdₒ(i.e., mfdₛ<mfdₒ), in which case, an order of coreless fiber 202 and 204 may be reversed. Stated in other words, when mfdₛ for fiber 201 is less than mfdₒ for fiber 204, graded index fiber 203 is between coreless fiber 202 and fiber 201, and coreless fiber 202 is between graded index fiber 203 and fiber 204 as discussed below with respect to Example 7 and FIG. 8.

According to Example 7, mode field adaptor 251′ may provide relatively efficient coupling between a solid core step index mode area fiber 201′ with optical mode field diameter mfdₛ′ and a hollow core (air core) inhibited coupling fiber 204′ (sometimes called anti-resonant fiber, or Kagome fiber) with optical mode field diameter mfdₒ′ as shown in FIG. 8. Optical mode field diameter mfdₒ of fiber 204′ may be larger than optical mode field diameter mfdₛ′ in the solid core step index fiber 201′. In Example 7 of FIG. 8, solid core step index fiber 201′ is a double clad output optical fiber with core diameter cdₛ′ of 20 μm and numerical aperture of 0.065, and an outer diameter ODₛ′ of 400 μm. Mode field diameter mfdₛ′ of Fiber 201′ is 18.5 μm, and Fiber 201′ is spliced to Fiber 203′. Light from Fiber 201′ propagates into a graded index fiber 203′. Fiber 203′ has a core of 100 μm and numerical aperture of 0.275. Length L₃′ of Fiber 203′ is 330 μm (where L₃ can be in the range of about 100 μm to 2000 μm). Coreless fiber 202′ made of solid silica glass is spliced to the end of graded index fiber 203′, and coreless fiber 202′ has a length of 200 μm. The endface of coreless fiber 202′ is etched to achieve an anti-reflective surface structure (ARSS) or moth-eye structures. The endface of Fiber 202′ is spliced to the hollow core fiber 204′). Fiber 204′ has an air core of 57 μm, and outer diameter ODₒ′ of 320 μm, and a mode field diameter mfdₒ′ of 39 μm. Because the center core of Fiber 204′ does not have glass, splicing Fiber 202′ output to Fiber 204′ may not significantly distort the center anti-reflection structures and/or may allow high power transmission. The power handling of the mode field adaptor 251′ may be greater than 3 kW. FIG. 8 illustrates a model of the coupling between the two fibers 201′ and 204′ with coupling power exceeding 95%.

More particularly, FIG. 8 illustrates an example of coupling between a solid core large mode area optical fiber 201′ and an anti-resonant optical fiber 204′ with mode field diameter mfdₒ′>1.5× larger that the diameter of the solid core Fiber 201′ (e.g., optical fiber 201′ may have a 20 μm mode field diameter and optical fiber 204′ may have a 39 μm mode field diameter). In Example 7 (FIG. 8), the order of GRIN fiber 203′ and coreless fiber 202′ is reversed in MFA 251′ relative to MFA 251 of FIGS. 2A-C, because MFA 251′ is coupling from a smaller mode field diameter mfdₛ′ to a larger mode field diameter mfdₒ.

According to Example 8, mode field adaptor 251 similar to the structure of FIGS. 2A-C may provide efficient coupling between fibers 201 and 204 which may be photonic crystal fibers. In Example 8, Fiber 201 is an endlessly single mode photonic crystal fiber with mode field diameter mfdₛ of 20.9 μm at a wavelength of 1064 nm, and fiber 204 is a photonic crystal fiber with mode field diameter mfdₒ of 4.7 μm. A portion of protective coating 271 of Fiber 201 is stripped and exposed to high temperatures to locally collapse the holes and form a collapse region with no core (not shown but similar to collapse region c1 of fiber 204), where the collapse region may act as a coreless fiber 202. The collapse region of fiber 201 is cleaved to a length (in this case 350 μm) and spliced to GRIN fiber 203. Fiber 204 may be exposed to heat to collapse the air holes over a narrow region (e.g., less than 1 mm). The collapsed region of fiber 204 is cleaved to a fixed length of 50 μm to provide collapse region c1. Graded index fiber 203 is spliced to the collapse region c1 of fiber 204 to complete the mode field adaptor 251. The collapsed air hole region of fiber 204 bonded to GRIN fiber 203 results in a strong bond. In Example 8, fibers 201 and 204 may also include cladding light strippers 211 and 241 as discussed above with respect to FIGS. 2A-C.

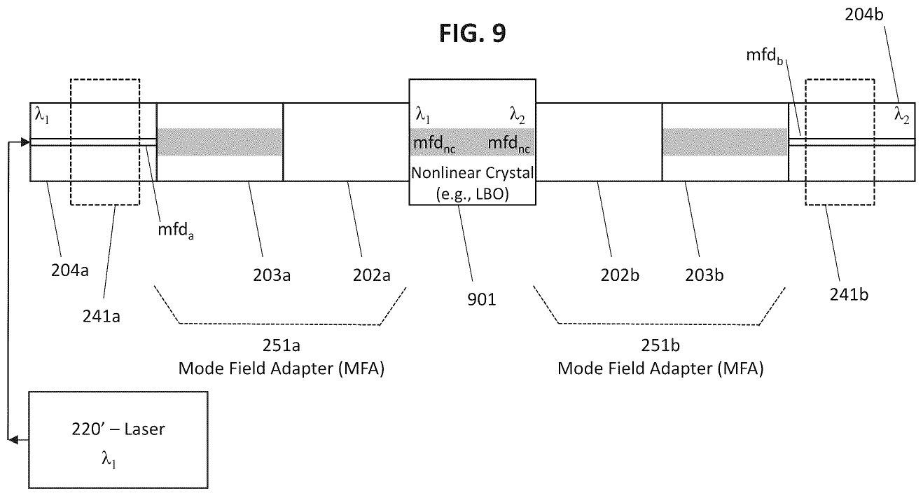

According to Example 9, an all-spliced dual-imaging mode field adaptor may include a nonlinear crystal 901 (such as a lithium triborate LBO crystal) as shown, for example, in FIG. 9 between mode field adapters 251a and 251b. Light emitted from laser 220′ (e.g., a high peak power fiber laser with >1 kW peak power) at a wavelength of 1064 nm propagates in the core of a double clad output optical fiber 204a with core diameter cdₛ of 20 μm, a numerical aperture of 0.065, an outer diameter ODₛ of 400 μm, and mode field diameter mfdₐ. Fiber 204a is spliced to mode field adapter 251a (including graded index optical fiber 203a and coreless fiber 202a) to increase the mode size to mfd_{nc} for nonlinear crystal 901 (e.g., mfd_{nc}=100 μm). The length of GRIN fiber 203a and/or coreless fiber 202a may be designed to form a collimated beam similar to that of Fibers 203′ and 202′ in Example 7 (illustrated in FIG. 8). Coreless fiber 202a is spliced to GRIN fiber 203a, and nonlinear crystal 901 (e.g., Lithium triborate LBO with thickness 1 mm, and width 1 mm) is spliced to the cleaved end of coreless fiber 202a such that the light propagates along the length of nonlinear crystal 901 having mode field diameter mfd_{nc}. According to some embodiments, nonlinear crystal 901 may be an LBO crystal with a length in the range of about 10 mm to about 30 mm and a mode field diameter mfd_{nc} greater than mfdₐ of fiber 204a and greater than mfd_{b} of fiber 204b. Coreless fiber 202b is spliced to nonlinear crystal 901, GRIN fiber 203b is spliced to coreless fiber 202b, and fiber 204b is spliced to GRIN fiber 203b. Mode field adapter 251b (including coreless fiber 202b and GRIN fiber 203b) receives the nonlinearly converted light from nonlinear crystal 901 (at a wavelength different than that of the fiber laser wavelength of 1064 nm) and images that light into Fiber 204b. Fiber 204b can be a photonic crystal fiber with mode field diameter mfd_{b} (such as 2 μm) less than a mode field diameter mfd_{nc}.

As shown in FIG. 9, mode field adapter 251a (including GRIN fiber 203a and coreless fiber 202a) adapts the light of wavelength λ₁ from the smaller mode field diameter mfdₐ of fiber 204a to the larger mode field diameter mfd_{nc} of nonlinear crystal 901; nonlinear crystal 901 converts the wavelength of the light from wavelength λ₁ to wavelength λ₂; and mode field adapter 251b (including coreless fiber 202b and GRIN fiber 203b) adapts the light of wavelength λ₂ from the larger mode field diameter mfd_{nc} of nonlinear crystal 901 to the smaller mode field diameter mfd_{b} of fiber 204b. Moreover, mode field diameters mfdₐ and mfd_{b} may be the same or different.

In FIG. 9, GRIN fiber 203a and coreless fiber 202a may be joined by fusion splicing, coreless fiber 202b and GRIN fiber 203b may be joined by fusion splicing, input fiber 204a and GRIN fiber 203a may be joined by fusion splicing, coreless fiber 202a and nonlinear crystal 901 may be joined by fusion splicing, coreless fiber 202b and nonlinear crystal 901 may be joined by fusion splicing, and GRIN fiber 203b and output fiber 204b may be joined by fusion splicing. In other embodiments where mode field diameter mfd_{nc} of nonlinear crystal 901 is less than mode field diameters mfdₐ and mfd_{b} of input and output fibers 204a and 204b, orders of fibers 203a and 202a may be reversed and orders of fibers 202b and 203b may be reversed such that coreless fiber 202a and input fiber 204a are joined by fusion splicing, GRIN fiber 203a and nonlinear crystal 901 are joined by fusion splicing, coreless fiber 202b and output fiber 204b are joined by fusion splicing, and GRIN fiber 203b and nonlinear crystal 901 are joined by fusion splicing.

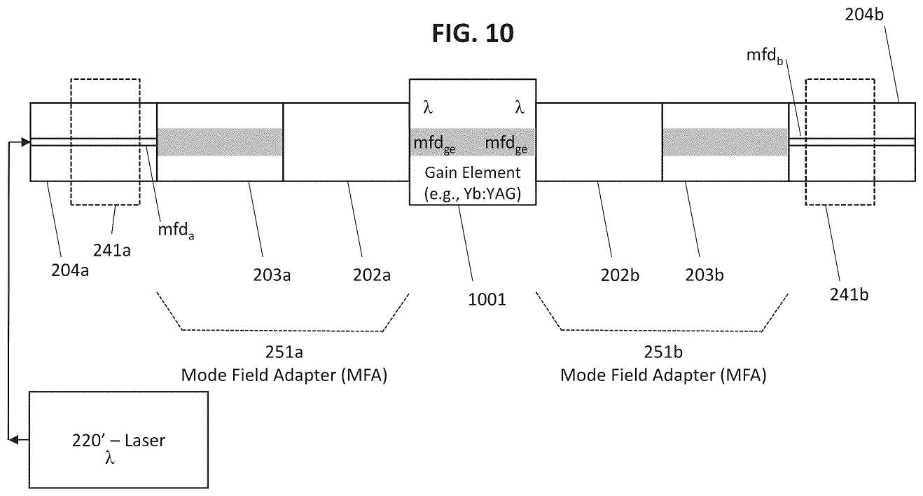

According to Example 10 illustrated in FIG. 10, an all-spliced dual-imaging mode field adaptor may include gain element 1001 between mode field adapters 251a and 251b. Laser 220′ may include a fiber laser and a signal/pump combiner. Light may be emitted from the seed diode of fiber laser at 1064 nm and launched into the signal input of the signal/pump combiner. Pump light at 910 nm, 940 nm or 976 nm is injected into the pump inputs of the signal/pump combiner. The signal pump combiner is spliced to a double clad optical fiber 204a with core diameter of 20 μm, numerical aperture of 0.065, and outer diameter of 400 μm such that the signal light propagates in the core and the pump light propagates in the cladding of fiber 204a. Fiber 204a is spliced to mode field adapter 251a (e.g., including graded index optical fiber 203a and coreless fiber 202a) such that the length of mode field adapter 251a is designed to focus both the pump and signal light from Fiber 204a to gain element 1001. Gain element 1001 may include a crystal gain material such as Ytterbium-doped Yttrium Aluminum Garnet (Yb:YAG) with thickness 1 mm, width 1 mm and length in the range of about 10 mm to about 30 mm (e.g., about 10 mm), and gain element 1001 is spliced to mode field adapter 251a (e.g., to a cleaved end of coreless fiber 202a) such that the light propagates along the length of the gain element 1001 while the pump excites the Yb:YAG to create gain at the signal wavelength. Second mode field adapter 251b (e.g., including coreless fiber 202b and graded index fiber 203b) receives the amplified signal light from gain element 1001 at 1064 nm) and images that light into fiber 204b. Fiber 204b can be a single mode fiber or a large mode area fiber. In Example 10, mode field diameters mfdₐ and mfd_{b} of fibers 204a and 204b may be less than mode field diameter mfd_{ge} of gain element 1001, and mode field diameters mfdₐ and mfd_{b} may be the same or different.

In FIG. 10, GRIN fiber 203a and coreless fiber 202a may be joined by fusion splicing, coreless fiber 202b and GRIN fiber 203b may be joined by fusion splicing, input fiber 204a and GRIN fiber 203a may be joined by fusion splicing, coreless fiber 202a and gain element 1001 may be joined by fusion splicing, coreless fiber 202b and gain element 1001 may be joined by fusion splicing, and GRIN fiber 203b and output fiber 204b may be joined by fusion splicing. In other embodiments where mode field diameter mfd_{nc} of gain element 1001 is less than mode field diameters mfdₐ and mfd_{b} of input and output fibers 204a and 204b, orders of fibers 203a and 202a may be reversed and orders of fibers 202b and 203b may be reversed such that coreless fiber 202a and input fiber 204a are joined by fusion splicing, GRIN fiber 203a and gain element 1001 are joined by fusion splicing, coreless fiber 202b and output fiber 204b are joined by fusion splicing, and GRIN fiber 203b and gain element 1001 are joined by fusion splicing.

According to Example 11, the all-spliced dual-imaging mode field adaptor including gain element 1001 of example 10 may be provided where the input seed diode of laser 220′ is replaced with a high reflectivity fiber grating at the signal wavelength of 1064 nm and where Fiber 204a includes a second partially reflecting fiber grating at 1064 nm to provide a laser cavity.

Some embodiments of inventive concepts described above may provide increased mechanical strength relative to the current state of the art mode field adaptors between solid core and photonic crystal fibers as well as between solid core and anti-resonant hollow core optical fibers.

Some embodiments of inventive concepts may be designed to operate in the range of 1 kW to 10 kW average optical power.

Some embodiments of inventive concepts may provide optical mode field reduction ratios in the range of about 3:1 to about 20:1, and more particularly about 7:1. Stated in other words, the mode field diameter of the source mfdₛ may be in the range of about 3 to 20 times greater than the mode field diameter of the output mfdₒ.

Some embodiments of inventive concepts may provide isolation between cladding power stripping and optical mode clean up and between mode conversion and optical mode clean up.

Some embodiments of inventive concepts may be thermally and/or mechanically symmetric for bi-directional use.

Some embodiments of inventive concepts may provide a mode field adaptor that can be a factor of 10 times shorter in length relative to current tapered fiber approaches. Reducing the fiber length may reduce the nonlinear broadening, and for typical powers, can be below a characteristic nonlinear length.

According to some embodiments of inventive concepts, the mode field adaptor approach may increase the size of the mode field diameter for a section of the propagation length (e.g., 25% to 75% of the length) and then reduce the size of the mode field diameter over the remaining length. The impact of the increased mode field size along the length of the mode field adaptor may include reduction of nonlinear broadening relative to propagation in the input passive fiber and/or cascaded/tapered fiber mode field adaptors.

Some embodiments of inventive concepts may reduce/minimizes changes to the spectral and/or temporal bandwidth of the input optical light.

Various embodiments of inventive concepts are discussed above with respect to the Figures, and further alternatives are discussed below. For example, input fiber 201 of FIG. 2A can have a core diameter cdₛ or 14 μm, 20 μm, or 25 μm. Input fiber 201 and/or output fiber 204 can be a polarization maintaining fiber and/or a single polarization transmission fiber. Output fiber 204 can be a photonic crystal fiber with a mode field diameter in the range of 3 μm to 8 μm. Output fiber 204 may be a hollow core fiber such as an antiresonant fiber and/or a photonic bandgap fiber. Each of fibers 201, 202, 203, and/or 204 may be provided using glass compositions such as tellurite, germanate, fluoride, and/or chalcogenide glass to achieve coupling in other wavelength ranges supported by these fiber (e.g., mid-wave-InfraRed or long-wave-InfraRed).

Additional embodiments are discussed below by way of example.

Embodiment 1. An optical device comprising: an optical source (201, 201′, 204a, 901, 1001) configured to provide source light having a first mode field diameter at a wavelength of the source light; a mode field adapter (251, 251′, 251b) optically coupled with the optical source, wherein the mode field adapter includes a coreless optical fiber (202, 202′, 202a, 202b) and a graded index optical fiber (203, 203′, 203b) optically coupled in series with the optical source, wherein the mode field adapter is configured to receive the source light having the first mode field diameter from the optical source and to provide output light having a second mode field diameter at the wavelength of the source light, and wherein the first and second mode field diameters are different; and an optical output fiber (204, 204′, 204b) having the second mode field diameter at the wavelength of the light, wherein the mode field adapter is optically coupled between the optical source and the optical output fiber, and wherein the optical output fiber and the mode field adapter are joined by a splice.

Embodiment 2. The optical device according to Embodiment 1, wherein the optical source includes an optical source fiber (201, 201′) configured to receive the source light from a source laser (220), wherein the optical source fiber has the first mode field diameter at the wavelength of the source light.

Embodiment 3. The optical device according to Embodiment 2, wherein the optical source fiber includes an optical source fiber core and an optical source fiber cladding having different refractive indices, and/or wherein the optical source fiber includes a photonic crystal fiber.

Embodiment 4. The optical device according to Embodiment 2, wherein the optical source fiber (201) includes an optical source fiber core (201a) and an optical source fiber cladding (201b) having different refractive indices, and wherein a plurality of notches (215) are provided in the optical source fiber cladding (201b) to strip light from the optical source fiber cladding.

Embodiment 5. The optical device according to Embodiment 1, wherein the optical source includes a nonlinear crystal (901) optically coupled with the mode field adaptor (251b), wherein the source light from the nonlinear crystal (901) has the first mode field diameter (mfd_{nc}).

Embodiment 6. The optical device according to Embodiment 1, wherein the optical source includes a gain element (1001), wherein the gain element is optically coupled with the mode field adaptor (251b), wherein the source light from the gain element (1001) has the first mode field diameter (mfd_{ge}).

Embodiment 7. The optical device according to any one or more of Embodiments 1-6, wherein the coreless optical fiber (202, 202b) is optically coupled in series between the optical source and the graded index optical fiber (203, 203b), and wherein the first mode field diameter is greater than the second mode field diameter.

Embodiment 8. The optical device according to Embodiment 7, wherein the optical source and the coreless optical fiber are joined by a splice, wherein the coreless optical fiber and the graded index optical fiber are joined by a splice, and wherein the graded index optical fiber and the output optical fiber are joined by a splice.

Embodiment 9. The optical device according to any one or more of Embodiments 1-6, wherein the graded index optical fiber (203′) is optically coupled in series between the optical source and the coreless optical fiber (202′), and wherein the first mode field diameter is less than the second mode field diameter.

Embodiment 10. The optical device according to Embodiment 9, wherein the optical source and the graded index optical fiber are joined by a splice, wherein the graded index optical fiber and the coreless optical fiber are joined by a splice, and wherein the coreless optical fiber and the optical output fiber are joined by a splice.

Embodiment 11. The optical device according to any one or more of Embodiments 1-10, wherein the optical output fiber includes an optical output fiber core and an optical output fiber cladding having different refractive indices, and/or wherein the optical output fiber includes a photonic crystal fiber, and/or wherein the optical output fiber includes a hollow core fiber.

Embodiment 12. The optical device according to any one or more of Embodiments 1-11, wherein the optical output fiber (204) includes an optical output fiber core (204a) and an optical output fiber cladding (204b) having different refractive indices, and wherein a plurality of notches (245) are provided in the optical output fiber cladding to strip light from the optical output fiber cladding.

Embodiment 13. An optical device comprising: an optical source (204a) configured to provide source light having a first mode field diameter (mfdₐ) at a first wavelength (λ₁); a first mode field adapter (251a) optically coupled with the optical source, wherein the first mode field adapter includes a first graded index optical fiber (203a) and a first coreless optical fiber (202a) optically coupled in series with the optical source, wherein the first mode field adapter is configured to receive the source light having the first mode field diameter from the optical source and to provide first output light having a second mode field diameter (mfd_{nc}) at the first wavelength (λ₁), and wherein the first and second mode field diameters are different; a nonlinear crystal (901), wherein the first graded index optical fiber and the first coreless optical fiber are optically coupled in series between the optical source and the nonlinear crystal, wherein the nonlinear crystal is configured to receive the first output light from the first mode field adapter, and wherein the nonlinear crystal is configured to provide second output light having the second mode field diameter and having a second wavelength (λ₂) different than the first wavelength in response to the first output light; a second mode field adapter (251b) wherein the nonlinear crystal is optically coupled between the first and second mode field adapters, wherein the second mode field adapter includes a second coreless optical fiber (202b) and a second graded index optical fiber (203b) optically coupled in series with the nonlinear crystal, wherein the second mode field adapter is configured to receive the second output light, and wherein the second mode field adapter is configured to provide third output light having a third mode field diameter (mfd_{b}) different than the second mode field diameter and having the second wavelength; and an optical output fiber (204b) having the third mode field diameter at the second wavelength, wherein the second coreless optical fiber and the second graded index optical fiber are optically coupled in series between the nonlinear crystal and the optical output fiber so that the output optical fiber receives the third output light.

Embodiment 14. The optical device according to Embodiment 13, wherein the nonlinear crystal comprises lithium triborate.

Embodiment 15. The optical device according to any one or more of Embodiments 13-14, wherein the first mode field adapter and the nonlinear crystal are joined by a splice, and wherein the nonlinear crystal and the second mode field adapter are joined by a splice.

Embodiment 16. An optical device comprising: an optical source (204a) configured to provide source light having a first mode field diameter at a first wavelength (λ₁); a first mode field adapter (251a) optically coupled with the optical source, wherein the first mode field adapter includes a first graded index optical fiber (203a) and a first coreless optical fiber (202a) optically coupled in series with the optical source, wherein the first mode field adapter is configured to receive the source light having the first mode field diameter from the optical source and to provide first output light having a second mode field diameter at the first wavelength (λ₁), and wherein the first and second mode field diameters are different; a gain element (1001), wherein the first coreless optical fiber and the first graded index optical fiber are optically coupled in series between the optical source and the gain element, wherein the gain element is configured to amplify the first output light from the first mode field adapter to provide second output light having the second mode field diameter; a second mode field adapter (251b), wherein the gain element is optically coupled between the first and second mode field adapters, wherein the second mode field adapter includes a second coreless optical fiber (202b) and a second graded index optical fiber (203b) optically coupled in series, wherein the second mode field adapter is configured to receive the second output light, and wherein the second mode field adapter is configured to provide third output light having a third mode field diameter different than the second mode field diameter; and an optical output fiber (204b) having the third mode field diameter at the wavelength, wherein the second coreless optical fiber and the second graded index optical fiber are optically coupled in series between the gain element and the optical output fiber so that the optical output fiber receives the third output light.

Embodiment 17. The optical device according to Embodiment 16, wherein the gain element comprises a single-crystal fiber gain material.

Embodiment 18. The optical device according to Embodiment 17, wherein the single-crystal fiber gain material comprises at least one of thulium doped yttrium aluminum garnet, titanium doped sapphire, erbium doped yttrium lithium fluoride, and/or ytterbium doped yttrium aluminum garnet.

Embodiment 19. The optical device according to any one or more of Embodiments 16-18, wherein the first mode field adapter and the gain element are joined by a splice, and wherein the gain element and the second mode field adapter are joined by a splice.

Embodiment 20. The optical device according to any one or more of Embodiments 13-19, wherein the first graded index fiber is optically coupled between the first coreless optical fiber and the optical source, and wherein the second graded index fiber is optically coupled between the second coreless optical fiber and the optical output fiber.

Embodiment 21. The optical device according to any one or more of Embodiments 13-20, wherein the first and third mode field diameters are less than the second mode field diameter.

Embodiment 22. The optical device according to any one or more of Embodiments 13-21, wherein the first and third mode field diameters are the same.

Embodiment 23. An optical device according to any one or more of Embodiments 13-22, wherein the optical source and the first graded index fiber are joined by a splice, and wherein the first graded index fiber and the first coreless optical fiber are joined by a splice.

Embodiment 24. An optical device according to any one or more of Embodiments 13-23, wherein the second coreless optical fiber and the second graded index optical fiber are joined by a splice, and wherein the second graded index optical fiber and the optical output fiber are joined by a splice.

Embodiment 25. An optical device according to any one or more of Embodiments 1-21, wherein the optical source includes an optical source fiber having the first mode field diameter at the wavelength of the source light, the optical device further comprising: a source laser configured to generate the source light, wherein the optical source fiber is configured to couple the source light from the source laser to the mode field adapter.

Each of the disclosures of the following references is hereby incorporated herein in its entirety by reference, and each of these references is attached as a respective appendix.
Reference [1]: K. Petermann, “Constraints for fundamental mode spot size for broadband dispersion-compensated single-mode fibers,” Electron. Lett., Vol. 19, Issue 18, pages 712-714 (Sep. 1, 1983).
Reference [2]: C. Pask, “Physical interpretation of Petermann's strange spot size for single-mode fibres,” Electron. Lett., Vol. 20, Issue 3, pages 144-145 (Feb. 2, 1984).
Reference [3]: M. John Matthewson, “Optical Fiber Reliability Models,” SPIE Fiber Optics Reliability and Testing, Critical Reviews of Optical Science and Technology, Vol. CR50, pages 3-31, 1993.

Additional disclosure is provided below.

The terminology used herein is for the purpose of describing particular embodiments only and is not intended to be limiting of inventive concepts. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. The term “and/or” includes any and all combinations of one or more of the associated listed items.

It will be understood that, although the terms first, second, third, etc. may be used herein to describe various elements, these elements should not be limited by these terms. These terms are only used to distinguish one element from another element. Thus, a first element discussed herein could be termed a second element without departing from the scope of the present inventive concepts.

It will also be understood that when an element is referred to as being “coupled” to/with or “connected” to/with another element, it can be directly coupled or connected to/with the other element, or intervening elements may be present. In contrast, when an element is referred to as being “directly coupled” to/with or “directly connected” to/with another element, there are no intervening elements present. Similarly, when an operation/element is referred to as being “responsive to” or “in response to” another event/operation/element, it can be directly responsive to or directly in response to the other operation/element or intervening events/operations/elements may be present. In contrast, when an operation/element is referred to as being “directly responsive to” or “directly in response to” another event/operation/element, there are no intervening events/operations/elements present.

Unless otherwise defined, all terms (including technical and scientific terms) used herein have the same meaning as commonly understood by one of ordinary skill in the art to which the inventive concepts herein belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments are described herein with reference to cross-sectional and/or perspective illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of the present inventive concept.

The operations of any methods disclosed herein do not have to be performed in the exact order disclosed, unless an operation is explicitly described as following or preceding another operation and/or where it is implicit that an operation must follow or precede another operation. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description herein.

While inventive concepts have been particularly shown and described with reference to examples of embodiments thereof, it will be understood that various changes in form and details may be made therein without departing from the spirit of concepts and/or embodiments disclosed herein and/or the following claims.

1. An optical device comprising:
an optical source configured to provide source light having a first mode field diameter at a wavelength of the source light;
a mode field adapter optically coupled with the optical source, wherein the mode field adapter includes a coreless optical fiber and a graded index optical fiber optically coupled in series with the optical source, wherein the mode field adapter is configured to receive the source light having the first mode field diameter from the optical source and to provide output light having a second mode field diameter at the wavelength of the source light, and wherein the first and second mode field diameters are different; and
an optical output fiber having the second mode field diameter at the wavelength of the light, wherein the mode field adapter is optically coupled between the optical source and the optical output fiber, and wherein the optical output fiber and the mode field adapter are joined by a splice.

2. The optical device according to claim 1, wherein the optical source includes an optical source fiber configured to receive the source light from a source laser, wherein the optical source fiber has the first mode field diameter at the wavelength of the source light.

3. The optical device according to claim 2, wherein the optical source fiber includes an optical source fiber core and an optical source fiber cladding having different refractive indices, and/or wherein the optical source fiber includes a photonic crystal fiber.

4. The optical device according to claim 2, wherein the optical source fiber includes an optical source fiber core and an optical source fiber cladding having different refractive indices, and wherein a plurality of notches are provided in the optical source fiber cladding to strip light from the optical source fiber cladding.

5. The optical device according to claim 1, wherein the optical source includes a nonlinear crystal optically coupled with the mode field adaptor, wherein the source light from the nonlinear crystal has the first mode field diameter.

6. The optical device according to claim 1, wherein the optical source includes a gain element, wherein the gain element is optically coupled with the mode field adaptor, wherein the source light from the gain element has the first mode field diameter.

7. The optical device according to claim 1, wherein the coreless optical fiber is optically coupled in series between the optical source and the graded index optical fiber, and wherein the first mode field diameter is greater than the second mode field diameter.

8. The optical device according to claim 7, wherein the optical source and the coreless optical fiber are joined by a splice, wherein the coreless optical fiber and the graded index optical fiber are joined by a splice, and wherein the graded index optical fiber and the output optical fiber are joined by a splice.

9. The optical device according to claim 1, wherein the graded index optical fiber is optically coupled in series between the optical source and the coreless optical fiber, and wherein the first mode field diameter is less than the second mode field diameter.

10. The optical device according to claim 9, wherein the optical source and the graded index optical fiber are joined by a splice, wherein the graded index optical fiber and the coreless optical fiber are joined by a splice, and wherein the coreless optical fiber and the optical output fiber are joined by a splice.

11. The optical device according to claim 1, wherein the optical output fiber includes an optical output fiber core and an optical output fiber cladding having different refractive indices, and/or wherein the optical output fiber includes a photonic crystal fiber, and/or wherein the optical output fiber includes a hollow core fiber.

12. The optical device according to claim 1, wherein the optical output fiber includes an optical output fiber core and an optical output fiber cladding having different refractive indices, and wherein a plurality of notches are provided in the optical output fiber cladding to strip light from the optical output fiber cladding.

13. An optical device comprising:
an optical source configured to provide source light having a first mode field diameter at a first wavelength;
a first mode field adapter optically coupled with the optical source, wherein the first mode field adapter includes a first graded index optical fiber and a first coreless optical fiber optically coupled in series with the optical source, wherein the first mode field adapter is configured to receive the source light having the first mode field diameter from the optical source and to provide first output light having a second mode field diameter at the first wavelength, and wherein the first and second mode field diameters are different;
a nonlinear crystal, wherein the first graded index optical fiber and the first coreless optical fiber are optically coupled in series between the optical source and the nonlinear crystal, wherein the nonlinear crystal is configured to receive the first output light from the first mode field adapter, and wherein the nonlinear crystal is configured to provide second output light having the second mode field diameter and having a second wavelength different than the first wavelength in response to the first output light;
a second mode field adapter wherein the nonlinear crystal is optically coupled between the first and second mode field adapters, wherein the second mode field adapter includes a second coreless optical fiber and a second graded index optical fiber optically coupled in series with the nonlinear crystal, wherein the second mode field adapter is configured to receive the second output light, and wherein the second mode field adapter is configured to provide third output light having a third mode field diameter different than the second mode field diameter and having the second wavelength; and
an optical output fiber having the third mode field diameter at the second wavelength, wherein the second coreless optical fiber and the second graded index optical fiber are optically coupled in series between the nonlinear crystal and the optical output fiber so that the output optical fiber receives the third output light.

14. The optical device according to claim 13, wherein the nonlinear crystal comprises lithium triborate.

15. The optical device according to claim 13, wherein the first mode field adapter and the nonlinear crystal are joined by a splice, and wherein the nonlinear crystal and the second mode field adapter are joined by a splice.

16. An optical device comprising:
an optical source configured to provide source light having a first mode field diameter at a first wavelength;
a first mode field adapter optically coupled with the optical source, wherein the first mode field adapter includes a first graded index optical fiber and a first coreless optical fiber optically coupled in series with the optical source, wherein the first mode field adapter is configured to receive the source light having the first mode field diameter from the optical source and to provide first output light having a second mode field diameter at the first wavelength, and wherein the first and second mode field diameters are different;
a gain element, wherein the first coreless optical fiber and the first graded index optical fiber are optically coupled in series between the optical source and the gain element, wherein the gain element is configured to amplify the first output light from the first mode field adapter to provide second output light having the second mode field diameter;
a second mode field adapter, wherein the gain element is optically coupled between the first and second mode field adapters, wherein the second mode field adapter includes a second coreless optical fiber and a second graded index optical fiber optically coupled in series, wherein the second mode field adapter is configured to receive the second output light, and wherein the second mode field adapter is configured to provide third output light having a third mode field diameter different than the second mode field diameter; and
an optical output fiber having the third mode field diameter at the wavelength, wherein the second coreless optical fiber and the second graded index optical fiber are optically coupled in series between the gain element and the optical output fiber so that the optical output fiber receives the third output light.

17. The optical device according to claim 16, wherein the gain element comprises a single-crystal fiber gain material.

18. The optical device according to claim 16, wherein the first mode field adapter and the gain element are joined by a splice, and wherein the gain element and the second mode field adapter are joined by a splice.

19. The optical device according to claim 16, wherein the first graded index fiber is optically coupled between the first coreless optical fiber and the optical source, and wherein the second graded index fiber is optically coupled between the second coreless optical fiber and the optical output fiber.

20. The optical device according to claim 16, wherein the first and third mode field diameters are less than the second mode field diameter.
